(19) United States
(12) Patent Application Publication
(10) Pub. No.: US 2005/0279601 A1
(43) Pub. Date: Dec. 22, 2005

(54) Torque-transmitting mechanisms for a planetary transmission

(76) Inventor: Thomas Tuday, Tecumseh, MI (US)

Correspondence Address: LESLIE C. HODGES;General Motors Corporation, Legal Staff, Mail Code 482-C23-B21, P.O. Box 300, Detroit, MI, 48265-3000, US

(21) Appl. No.: 10/872,045

(22) Filed: Jun. 17, 2004

(51) Int. Cl. F16D 28/00

(52) U.S. Cl. 192/20; 192/93 A; 192/84.6

(57) ABSTRACT

A power transmission includes a plurality of torque-transmitting mechanisms, such as clutches and brakes. Each clutch and/or brake includes an apply piston, which is operatively drivingly connected with a stationary portion of the transmission and a rotating gear member having a cam surface formed thereon to enforce axial movement of each apply piston to thereby enforce engagement of the respective torque-transmitting mechanisms.

### TECHNICAL FIELD

This invention relates to torque-transmitting mechanisms and, more particularly, to torque-transmitting mechanisms for a planetary transmission wherein at least one member of the torque-transmitting mechanism is housed in a stationary component of the transmission.

### BACKGROUND OF THE INVENTION

Multi-speed planetary transmissions have at least one torque-transmitting mechanism and generally more than one. The torque-transmitting mechanisms are either of the stationary type, commonly termed brakes, or of the rotating type, commonly termed clutches. In rotating type torque-transmitting mechanisms, the apply piston is generally slidably disposed in a rotating housing through which at least a portion of the friction plates of the torque-transmitting mechanisms are splined. The torque-transmitting mechanisms are engaged by hydraulic forces, which act on the apply piston, to cause frictional engagement between the interdigitated friction plates. The friction plates then transmit torque from one transmission component to another. In the case of a rotating type torque-transmitting mechanism, the torque is transmitted between two rotating components, while in a brake type torque-transmitting mechanism, the torque is transmitted from a transmission member to a stationary housing.

The hydraulic apply system for the torque-transmitting mechanisms requires the direction or communication of high pressure hydraulic fluid from a control pump to the piston chambers for each of the torque-transmitting mechanisms. This requires that hydraulic fluid be ported throughout the transmission assembly so that all of the torque-transmitting mechanisms can be controlled.

In the case of stacked or nested torque-transmitting mechanisms, the hydraulic fluid will follow a tortuous path to get to at least one of the nested torque-transmitting mechanisms. Also, in lieu of these construction difficulties, it has been proposed to provide stationary apply pistons for each of the torque-transmitting mechanisms. However, this still requires a significant amount of hydraulic fluid routing throughout the transmission housing in order to supply fluid to each of the torque-transmitting mechanisms in transmissions where a significant number such as five torque-transmitting mechanisms may be employed.

### SUMMARY OF THE INVENTION

The present invention provides an improved torque-transmitting mechanism for a planetary-type power transmission.

In one aspect of the present invention, the torque-transmitting mechanism has an apply member that is rotatably disposed in a stationary housing.

In another aspect of the present invention, the apply member is driven in rotary motion by an electric motor and worm gear arrangement.

In yet another aspect of the present invention, the apply member has a cam portion formed thereon, which cooperates with a plurality of rollers on another stationary portion of the torque-transmitting mechanism to apply an axial force to at least one member of the torque-transmitting mechanism.

In yet still another aspect of the present invention, the torque-transmitting mechanism has a gear member rotatably disposed in a stationary housing, a worm thread formed on the outer periphery of the gear member, a cam formed on an axially-facing surface of the gear member, and an apply piston having a roller member disposed between the gear member and the torque-transmitting mechanism friction plate.

In still another aspect of the present invention, the gear member is rotated by an electrically motor driven worm gear to enforce axial movement of the apply piston whereby the torque-transmitting mechanism is controlled in engagement and disengagement by rotation of the worm gear.

### BRIEF DESCRIPTION OF THE DRAWINGS

FIG. 1 is a cross-sectional elevational view of a multi-speed planetary transmission having a plurality of torque-transmitting mechanisms, each of which incorporates the present invention.

FIG. 2 is a cross-sectional view taken along line 2-2 of FIG. 1.

FIG. 3 is a cross-sectional view taken along line 3-3 of FIG. 1.

FIG. 4 is an expanded view of a portion of one of the torque-transmitting mechanisms shown in FIG. 1.

FIG. 5 is an exploded isometric view of the apply plate and drive motor for one of the torque-transmitting mechanisms.

### DESCRIPTION OF THE PREFERRED EMBODIMENT

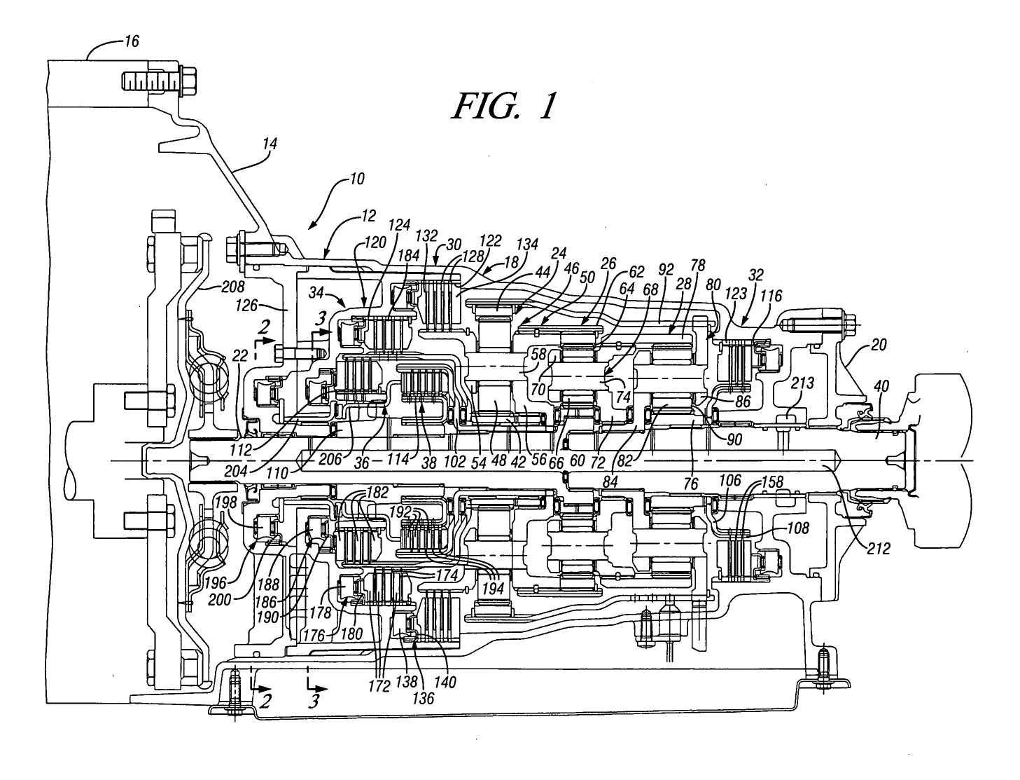

Referring to the drawings, wherein like characters represent the same or corresponding parts throughout the several views, there is seen in FIG. 1 a power transmission 10 having a multi-piece housing 12. The housing 12 includes a bell housing 14, which connects the transmission 10 with an engine 16, a main housing 18, and an end cover or end housing 20. The end housing 20 closes the end of the transmission to prevent leakage of lubrication cooling fluid therefrom. The transmission 10 also includes an input shaft 22, three planetary gearsets 24, 26, and 28, and five torque-transmitting mechanisms 30, 32, 34, 36, and 38, and an output shaft 40.

The planetary gearset 24 includes a sun gear member 42, a ring gear member 44, and a planet carrier assembly member 46. The planet carrier assembly member 46 includes a plurality of pinion gears 48 rotatably mounted on a planet carrier member 50, which consists of two side plates 54 and 56 and a plurality of pin members 58. The pinion gears 48 are rotatably mounted on the pins 58 and disposed in meshing relationship with the sun gear member 42 and the ring gear member 44.

The planetary gearset 26 includes a sun gear member 60, a ring gear member 62, and a planet carrier assembly member 64. The planet carrier assembly member 64 includes a plurality of pinion gears 66, and a planet carrier member 68. The planet carrier member 68 consists of a pair of side plates 70 and 72, and a plurality of pin members 74. The pinion gears 66 are rotatably mounted on the pin members 74 and disposed in meshing relationship with the sun gear member 60 and the ring gear member 62.

The planetary gearset 28 includes a sun gear member 76, a ring gear member 78, and a planet carrier assembly member 80. The planet carrier assembly member 80 includes a plurality of pinion gears 82, a pair of side plates 84 and 86, and a plurality of pin members 90. The pinion gears 82 are rotatably mounted on the pin members 90 and disposed in meshing relationship with the sun gear member 76 and the ring gear member 78.

The sun gear member 60 is continuously connected with the input shaft 22. The planet carrier assembly member 80 is continuously connected with the ring gear member 44 through a hub or drum member 92. The planet carrier assembly member 64 and ring gear member 78 are continuously interconnected. The planet carrier assembly member 46 and the ring gear member 62 are continuously interconnected.

The side plate 54 of the planet carrier assembly member 46 has a splined hub portion 94. The sun gear member 42 is connected with a hub 96, which has a first splined portion 98 and a second splined portion 100. The side plate 56 of the planet carrier assembly member 46 has a hub portion 102 having a splined portion 104. The sun gear member 76 is connected with a drum or hub portion 106 having a splined portion 108. A hub and drum 110 is drivingly connected with the input shaft 22 and includes a first splined portion 112 and a second splined portion 114.

The transmission housing 18 has a splined portion 116. A bulkhead 120 is secured in the transmission housing 12 and has formed therein three splined portions 122, 123, and 124. A second bulkhead 126 is also secured in the housing 12 to ensure that the bulkhead 120 remains in position.

The torque-transmitting mechanism 30 includes a plurality of friction discs 128 splined to the splined portion 122 and a plurality of friction plates 130 splined to the splined portion 94. Also included within the torque-transmitting mechanism 30 are an apply plate 132 and a backing plate 134, both of which are splined with the splined portion 122. The torque-transmitting mechanism 30 has a gear and an apply piston assembly 136 comprised of a gear portion 138 and an apply piston 140.

As seen in FIG. 5, the gear 138 includes a worm thread 142, an axial face 144, and a plurality of cams or ramps 146. The apply piston 140 has disposed thereon a plurality of rollers 148, which are disposed in rolling relationship with respective cam surfaces 146. An electric motor 150 is disposed to drive a worm gear 152, which meshes with the worm thread 142 formed on the gear member 138. As the motor 150 drives the worm gear 152, the gear 138 will be rotated such that the apply piston 140 will be forced axially by the action between the ramps 146 and the rollers 148 such that axial movement of the apply piston 140 will occur. When the apply piston 140 moves axially, the plates 128 and 130 are brought into frictional engagement, which will enforce a torque-transmitting connection between the planet carrier assembly member 46, the ring gear member 62, and the transmission housing 12. Thus, the torque-transmitting mechanism 30 operates as a stationary-type torque-transmitting mechanism, commonly termed a brake.

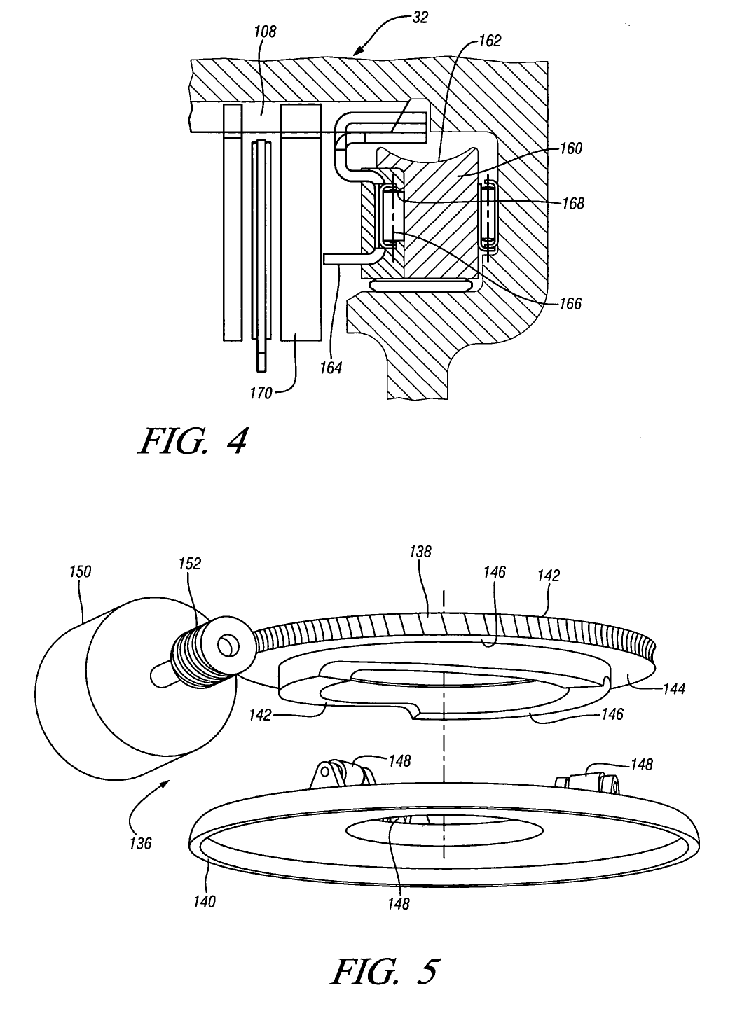

The torque-transmitting mechanism 32, as seen in FIGS. 1 and 4, includes a plurality of plates 154 splined to the splined portion 116, a plurality of friction discs or plates 156 splined to the splined portion 108 and therefore connected with the sun gear member 76. The torque-transmitting mechanism 32 also includes a gear member 160 having a worm thread 162 formed on the outer periphery thereof, and an apply piston 164 having connected therewith a plurality of rollers 166, which abut respective cam surfaces or ramps 168 formed on the gear 160. As described above with the torque-transmitting mechanism 30, the gear member 160 is rotated by an electric motor and worm gear, not shown, to enforce rotation of the gear member 160 and therefore axial movement of the apply piston 164. As the apply piston 164 is moved axially, it will contact a pressure plate 170, which is splined to the splined portion 108 to enforce the engagement of the plates 154 and 158. The torque-transmitting mechanism 32 is also a stationary-type torque-transmitting mechanism or a brake.

The torque-transmitting mechanism 34 includes a plurality of plates 172 and 174, which are splined to the splined portions 124 and 98, respectively. The axially outer plates 172 provide a pressure plate and a backing plate for the torque-transmitting mechanism 34. The torque-transmitting mechanism 34 also includes a gear and apply piston assembly 176 comprised of a gear member 178 and an apply piston 180. This assembly is similar in construction to the assembly 136. The gear member 178 is rotatably disposed in the bulkhead 120 and the apply piston 180 is splined to the splined portion 124. As described previously with the torque-transmitting mechanisms 30 and 32, as the gear 178 is rotated by an electric motor and worm, not shown, the apply piston 180 will be moved axially to enforce frictional engagement between the plates 172 and 174, thereby connecting the sun gear member 42 with the bulkhead 120 and housing 12. Thus, the torque-transmitting mechanism 34 is also of the stationary-type torque-transmitting mechanism, commonly termed a brake.

The torque-transmitting mechanism 36 includes a plurality of plates 182 interdigitated with a plurality of plates 184 which are splined to the splined portion& 112 and 100, respectively. The torque-transmitting mechanism 36 also includes a gear and apply piston assembly 186, which is similar in construction to the assemblies 136 and 176 and therefore includes a gear member 188 and an apply piston 190. The gear member 188 is rotatably disposed on the bulkhead 120 and engaged by a worm gear and drive motor, not shown. As the worm gear drives the gear member 188 in a rotary fashion, the apply piston 190 is moved axially to enforce frictional engagement between the plates 182 and 184, thereby connecting the input shaft 22 with the sun gear member 42. The torque-transmitting mechanism 36 is a rotating-type torque-transmitting mechanism, commonly termed a clutch.

The torque-transmitting mechanism 38 includes a plurality of discs or plates 192, which are alternately spaced with a plurality of plates 194. The plates 192 are drivingly connected with the splined portion 114 and the plates 194 are drivingly connected with the splined portion 104. The torque-transmitting mechanism 38 also includes a gear and apply piston assembly 196. As with the previously-described gear and apply piston assemblies, the gear and apply piston assembly 196 includes a gear member 198 and an apply piston member 200. The apply piston member 200 abuts a disc or plate 202, which is in abutment with a hub or sleeve 204, which further abuts a hub or sleeve 206. The sleeve 206 is aligned axially to enforce engagement between the plates 192 and 194 when the gear 198 is rotated by an electric motor and worm gear assembly, not shown. The action of the gear and apply piston assembly 196 is the same as the action described above for the other gear and apply piston assemblies, such as 136. The torque-transmitting mechanism 38, when applied, provides a drive or torque-transmitting connection between the input shaft 22 and the planet carrier assembly member 46. The torque-transmitting mechanism 38 is therefore a rotating-type torque-transmitting mechanism, commonly termed a clutch.

The input shaft 22 is drivingly connected with a damper plate assembly 208, which is secured to a flywheel or output member 210 of the engine 16. Those skilled in the art will recognize that the torque-transmitting mechanisms 30, 32, 34, 36, and 38 can be engaged in combinations of two to establish six forward speed ratios and one reverse speed ratio between the input shaft 22 and the output shaft 40.

The first forward speed ratio is established with the engagement of the torque-transmitting mechanisms 30 and 32. The second forward speed ratio is established with the engagement of the torque-transmitting mechanisms 32 and 34. The third forward speed ratio is established with the engagement of the torque-transmitting mechanisms 32 and 36. The fourth forward speed ratio is established with the engagement of the torque-transmitting mechanisms 32 and 38. The fifth forward speed ratio is established with the engagement of the torque-transmitting mechanisms 38 and 36. The sixth forward speed ratio is established with the engagement of the torque-transmitting mechanisms 38 and 34. The reverse speed ratio is established with the engagement of the torque-transmitting mechanisms 30 and 36.

Since there is a positive drive connection shown between the engine 16 and the input shaft 22, the torque-transmitting mechanisms 32 and 36 are designed to provide starting devices for the transmission. That is, during the first forward speed ratio, the torque-transmitting mechanism 30 will be engaged and then the torque-transmitting mechanism 32 will be brought on or engaged in a controlled manner to establish a torque path between the input shaft 22 and the output shaft 40. During the reverse speed ratio, the torque-transmitting mechanism 30 will be engaged and then the torque-transmitting mechanism 36 will be engaged in a controlled manner to establish the torque path between the input shaft 22 and the output shaft 40. Note that on a forward-to-reverse interchange, the torque-transmitting mechanism 30 can remain engaged while the torque-transmitting mechanisms 32 and 36 are interchanged. Those skilled in the art will also appreciate that each of the forward interchanges are of the single transition variety. That is, one torque-transmitting mechanism is disengaged while another torque-transmitting mechanism is being engaged, and at least one torque-transmitting mechanism remains engaged through the ratio change.

The only fluid requirements of the transmission are for lubrication and cooling, and this can be provided, in most instances, by a single fluid path or channel 212 formed in the input shaft 22 and the output shaft 40. A plurality of radial channels are then connected with the central path 212 to provide oil flow for lubrication and cooling to the various components of the transmission. The fluid can be supplied to the channel or path 212 through a channel 213 formed in the housing 12 and connected with a sump pump, not shown. Since both the sump pump and the housing 12 are stationary, the only rotary seals needed are those formed between the housing 12 and the output shaft 40. The oil flowing in a path formed between rotating seals is a very low pressure and therefore minimal. It will be noted that the only oil flow to any of the friction devices is that of cooling and lubrication. The apply mechanisms, due to the small amount of rotary movement and axial movement, will require only minor lubrication to maintain the bearings well lubricated such that the action between the gear and the apply piston is essentially frictionless.

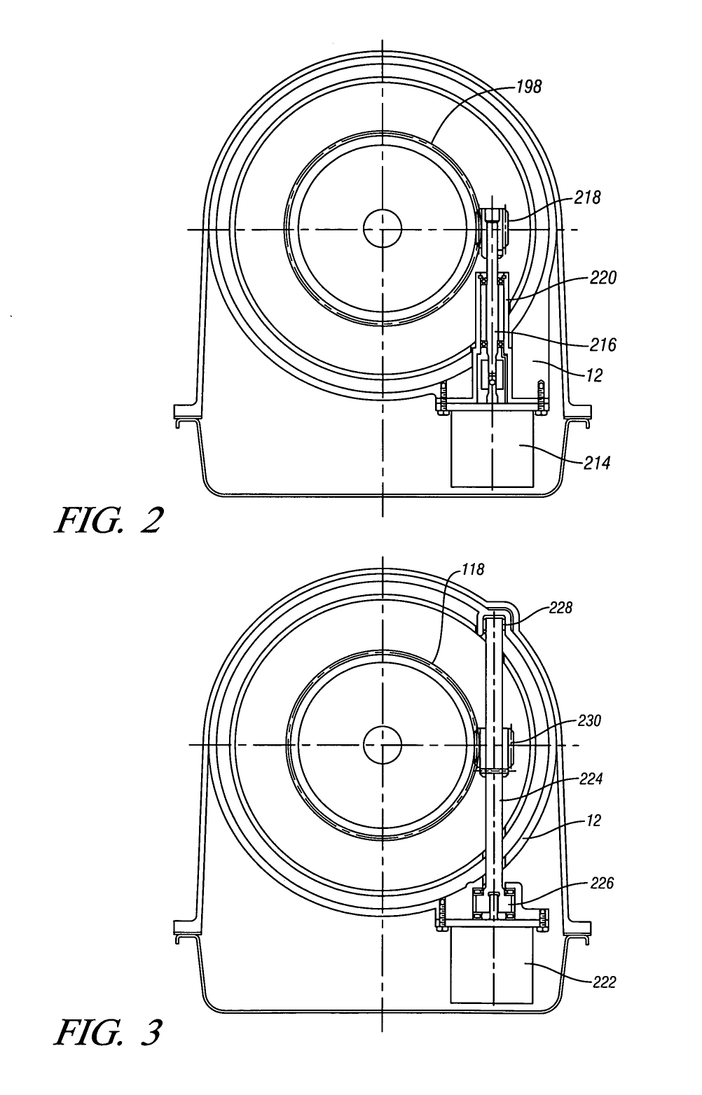

As seen in FIG. 2, an electric motor 214 is secured to the housing 12. An output shaft 216 of the electric motor 214 drives a worm gear 218, which meshingly engages the gear member 198 of the torque-transmitting mechanism 38. The housing 12 has disposed therein a support sleeve 220 on which the shaft 216 is rotatably supported.

As seen in FIG. 3, an electric motor 222 has a drive shaft 224, which is supported in the housing 12 at one end 226 by a plurality of bearings and also supported in a bushing 228 at the opposite end of the shaft 224. At approximately the center of the shaft 224, a worm gear 230 is drivingly connected. The worm gear 230 meshingly engages the gear member 188 of the torque-transmitting mechanism 36.

FIGS. 2 and 3 are examples of the structures that might be used with the worm gear drives for the remaining torque-transmitting mechanisms 30, 32 and 34. Each of these torque-transmitting mechanisms may have a drive shaft and worm gear that is supported at a single end, such as that shown in FIG. 2, or at two ends, such as that shown in FIG. 3. The type of support structure employed will, in part, depend upon the amount of room available for the support and the choice of the designer.

While the rotatable support components for the various elements within the transmission is met and discussed, those skilled in the art will recognize that a plurality of bearings and bushings are required within the transmission to absorb both rotary forces and thrust forces, which will occur during the transmission of power from the input shaft 22 to the output shaft 40. These are common design elements and a further description of these conventional support units is not considered necessary at this point for those skilled in the art to understand the scope of the invention.

1. A torque-transmitting mechanism for a power transmission comprising:
a first housing;
a plurality of first friction plates drivingly connected with said first housing;
a plurality of second friction plates alternately interspersed with said first friction plates and being drivingly connected with a rotatable transmission member;
an apply mechanism having a piston operatively engaging one of said first and second friction plates and being drivingly connected with a stationary housing;
a rotatable member supported in said stationary housing and operatively engaging said piston to move said piston to enforce frictional engagement of said first and second friction plates and having a gear member formed thereon; and
a drive gear means engaging said gear member to enforce rotation thereof to control selective engagement and disengagement of said torque-transmitting mechanism.

2. The torque-transmitting mechanism defined in claim 1 wherein:
said first housing is connected with another rotatable transmission member.

3. The torque-transmitting mechanism defined in claim 1 wherein:
said first housing is connected with said stationary housing.

4. The torque-transmitting mechanism defined in claim 1 wherein:
said gear member includes a worm thread and said gear means comprises a worm gear meshing with said worm thread.

5. The torque-transmitting mechanism defined in claim 1 further comprising:
a bearing means disposed between said piston and said rotatable member to support relative rotating therebetween.

6. The torque-transmitting mechanism defined in claim 2 further comprising:
a bearing means disposed between said apply piston and said one friction plate operatively engaged thereby to support relative rotation therebetween.
